(19) United States
(12) Patent Application Publication
(10) Pub. No.: US 2019/0059641 A1
(43) Pub. Date: Feb. 28, 2019

(54) RESTAURANT SCHEDULING PROCESSES AND SYSTEMS

(71) Applicant: Taylor Commercial Foodservice Inc., Rockton, IL (US)

(72) Inventors: James J. Minard, Roscoe, IL (US); Jeffrey L. Sands, Freeport, IL (US)

(73) Assignee: Taylor Commercial Foodservice Inc., Rockton, IL (US)

(21) Appl. No.: 16/106,960

(22) Filed: Aug. 21, 2018

Related U.S. Application Data
(60) Provisional application No. 62/550,078, filed on Aug. 25, 2017.

(51) Int. Cl. A47J 36/32; G09B 19/00; A47J 37/07; G06Q 10/10; G06Q 20/18; G05B 19/042

(52) U.S. Cl. CPC A47J 36/321; G09B 19/0092; A47J 37/0786; G05B 2219/2643; G06Q 20/18; G05B 19/042; G06Q 10/1093

(57) ABSTRACT

Methods and systems are provided to generate predictive food preparation schedules for restaurants or other stores or establishments. The processes include obtaining, at a control unit, data from one or more sources associated with a restaurant and generating a predictive food preparation schedule based on the obtained data, the predictive food preparation schedule indicating a number of items to be prepared in advance of at least one of a given time and event.

### RELATED APPLICATION

The present patent document claims the benefit of the filing date under 35 U.S.C. § 119(e) of Provisional U.S. Patent Application Ser. No. 62/550,078, filed Aug. 25, 2017, which is hereby incorporated by reference.

### BACKGROUND

The subject matter disclosed herein generally relates to restaurants and food preparation establishments and, more particularly, to scheduling for food preparation at restaurants and food preparation establishments.

Often the demand for food products to be prepared in a restaurant is variable and sporadic, particularly at fast-food or other eat-in or take-out dining establishments. For example, preparation of grilled foods in particular may be of such variability that waste and/or time delays may result due to variable states of demand and preparation. Such variability can lead to personnel of a restaurant cooking and/or preparing more food product than is required, which can result in waste, or not cooking enough product resulting in long customer wait times. The waste issue may arise due to mandatory limits or restrictions on how long a food product can be left waiting for a customer (e.g., time from being cooked to time of serving). Such issues are further complicated by having customers arrive in large groups, on busses or queuing up at a drive-through, which can cause visibility issues related to incoming demand for the personnel inside the restaurant.

### SUMMARY

According to some embodiments, methods to generate predictive food preparation schedules are provided. The methods include obtaining, at a control unit, data from one or more sources associated with a restaurant and generating a predictive food preparation schedule based on the obtained data, the predictive food preparation schedule indicating a number of items to be prepared in advance of at least one of a given time and event.

In addition to one or more of the features described herein, or as an alternative, further embodiments of the methods may include that the one or more sources comprise at least one of: a first point-of-sale system associated with a counter within the restaurant; a second point-of-sale system associated with a drive-through of the restaurant; occupancy sensors associated with one or more areas within the restaurant; monitoring sensors associated with a drive-through line or area; parking lot sensors associated with a parking lot of the restaurant; historical data related to orders made at the restaurant; weather data associated with a location of the restaurant; social media data associated with events in a locale of the restaurant; local news data associated with the locale of the restaurant; event data associated with the locale of the restaurant; day of week information; time of day information; proximity information related to nearby businesses, parks, stadiums, highway exits; mobile and online order information made from remote customers for food from the restaurant; and kiosk ordering within the restaurant.

In addition to one or more of the features described herein, or as an alternative, further embodiments of the methods may include displaying the generated predictive food preparation schedule on a display within a kitchen of the restaurant.

In addition to one or more of the features described herein, or as an alternative, further embodiments of the methods may include controlling an automated food preparation system based on the predictive food preparation schedule to prepare food in accordance with the predictive food preparation schedule.

In addition to one or more of the features described herein, or as an alternative, further embodiments of the methods may include that the automated food preparation system is an automated grill system.

In addition to one or more of the features described herein, or as an alternative, further embodiments of the methods may include that the control unit is located at least one of within the restaurant, located at another restaurant, and located on one or more remote servers.

In addition to one or more of the features described herein, or as an alternative, further embodiments of the methods may include receiving a manual input that overrides the predictive food preparation schedule.

According to some embodiments, methods to control automated food preparation systems are provided. The methods include obtaining, at a control unit, data from one or more sources associated with a restaurant, generating a predictive food preparation schedule based on the obtained data, the predictive food preparation schedule indicating a number of items to be prepared in advance of at least one of a given time and event, and controlling an automated food preparation system based on the predictive food preparation schedule to prepare food in accordance with the predictive food preparation schedule.

In addition to one or more of the features described herein, or as an alternative, further embodiments of the methods may include that the one or more sources comprise at least one of: a first point-of-sale system associated with a counter within the restaurant; a second point-of-sale system associated with a drive-through of the restaurant; occupancy sensors associated with one or more areas within the restaurant; monitoring sensors associated with a drive-through line or area; parking lot sensors associated with a parking lot of the restaurant; historical data related to orders made at the restaurant; weather data associated with a location of the restaurant; social media data associated with events in a locale of the restaurant; local news data associated with the locale of the restaurant; event data associated with the locale of the restaurant; day of week information; time of day information; proximity information related to nearby businesses, parks, stadiums, highway exits; mobile and online order information made from remote customers for food from the restaurant; and kiosk ordering within the restaurant.

In addition to one or more of the features described herein, or as an alternative, further embodiments of the methods may include displaying the generated predictive food preparation schedule on a display within a kitchen of the restaurant.

In addition to one or more of the features described herein, or as an alternative, further embodiments of the methods may include that the automated food preparation system is an automated grill system.

In addition to one or more of the features described herein, or as an alternative, further embodiments of the methods may include that the control unit is located at least one of within the restaurant, located at another restaurant, and located on one or more remote servers.

In addition to one or more of the features described herein, or as an alternative, further embodiments of the methods may include receiving a manual input that overrides the predictive food preparation schedule.

According to some embodiments, automated food preparation systems are provided. The automated food preparation systems include a control unit, a food storage station for holding unprepared food items, a cooking station for receiving one or more items from the food storage station and cooking the one or more unprepared food items, and a staging station for preparing and assembling ordered items form the unprepared food items and the cooked food items, wherein the control unit controls each of the food storage station, the cooking station, and the staging station, and wherein the control unit obtains data from one or more sources associated with a restaurant and generates a predictive food preparation schedule based on the obtained data, the predictive food preparation schedule indicating a number of items to be prepared in advance of at least one of a given time and event, the control unit controlling the food storage station, the cooking station, and the staging station based on the predictive food preparation schedule.

In addition to one or more of the features described herein, or as an alternative, further embodiments of the automated food preparation systems may include that the one or more sources comprise at least one of: a first point-of-sale system associated with a counter within the restaurant; a second point-of-sale system associated with a drive-through of the restaurant; occupancy sensors associated with one or more areas within the restaurant; monitoring sensors associated with a drive-through line or area; parking lot sensors associated with a parking lot of the restaurant; historical data related to orders made at the restaurant; weather data associated with a location of the restaurant; social media data associated with events in a locale of the restaurant; local news data associated with the locale of the restaurant; event data associated with the locale of the restaurant; day of week information; time of day information; proximity information related to nearby businesses, parks, stadiums, highway exits; mobile and online order information made from remote customers for food from the restaurant; and kiosk ordering within the restaurant.

In addition to one or more of the features described herein, or as an alternative, further embodiments of the automated food preparation systems may include a display for displaying the generated predictive food preparation schedule on a display within a kitchen of the restaurant.

In addition to one or more of the features described herein, or as an alternative, further embodiments of the automated food preparation systems may include that the cooking station is an automated grill station.

In addition to one or more of the features described herein, or as an alternative, further embodiments of the automated food preparation systems may include that the control unit is located at least one of within the restaurant, located at another restaurant, and located on one or more remote servers.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of a restaurant that may incorporate embodiments of the present disclosure; and

FIG. 2 is a schematic illustration of a system in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Embodiments described here are directed to food preparation-management systems and processes that utilize multiple data sources to predictively determine and output a predictive food preparation schedule (e.g., predictive schedule for food to be prepared). Embodiments of the present disclosure can include collected data from multiple sources, including, but not limited to, average hourly demand for the past three days at the location, hourly demand for the same hour on the same day for the past three years, sensors or occupancy information for a lobby/dining area, and sensors or occupancy information for drive-through lanes. The collected information can then be aggregated at a processing unit to generate a schedule for food preparation. For example, taking all the aggregated data a prediction of demand needed for food preparation can be generated. In such an example, with respect to grilling, suggested products to be cooked/prepared prior to an actual demand from a register or other point-of-sale (POS) system can be provided. The predictive load can be overridden in a positive or negative count manually at the location (e.g., using a computer or the processing unit) based on actual demands needs.

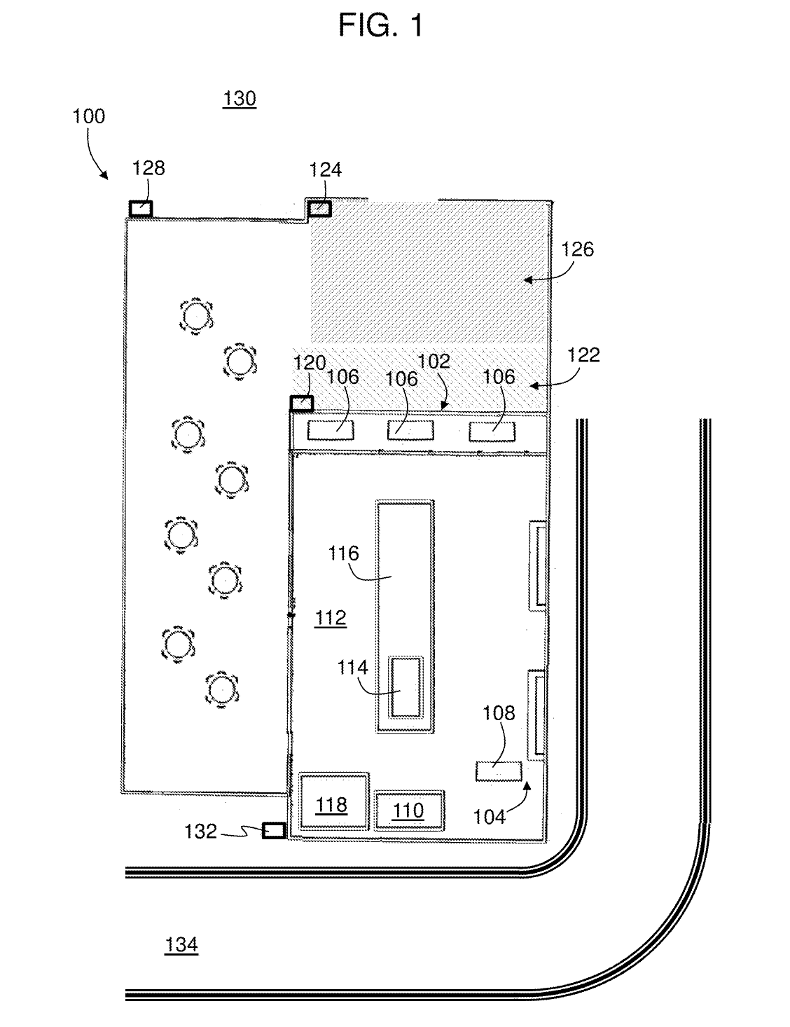

Turning to FIG. 1, a schematic illustration of a restaurant 100 that can incorporate embodiments of the present disclosure is shown. The restaurant 100 may be a location serving fast-food, and thus include a first service counter 102 (e.g., in-store service) and a second service counter 104 (e.g., drive-through service). The first and second service counters 102, 104 include respective point-of-sale systems 106, 108 that are configured to receive inputs regarding service orders, such as customer food orders. The point-of-sale systems 106, 108 are in communication with a control unit 110 that receives the inputs at the point-of-sale systems 106, 108 and generates an order list for prompting preparation of food to fulfill the orders.

The food is prepared within a kitchen 112 of the restaurant 100. The kitchen includes, for example, a cooking station 114, a staging station 116, and a food storage station 118. The cooking station 114 can include a grill, fryers, stove tops, cooking surfaces, ovens, microwaves, heaters, etc., as will be appreciated by those of skill in the art. The staging station 116 is used for assembly of orders. For example, the staging station 116 may receive cooked foods from the cooking station 114 and then combine the cooked food with appropriate additional items. In one non-limiting example, a hamburger patty may be cooked at the cooking station 114 and then the cooked patty is transferred to the staging station 116 to assemble a hamburger assembled to a customer's order request (e.g., additional of condiments, vegetables, and assembly on a bun). Similarly staging may be applied to salads, fries, or any other food order that the restaurant offers. The food storage station 118 can be a freezer, fridge, and/or dry storage area where raw and/or unassembled food items are stored.

When an order is made at one of the service counters 102, 104 and such order is entered into a respective point-of-sale system 106, 108, the food orders are input into the control unit 110. Simultaneously, typically, personnel in the kitchen 112 will hear the orders as they are made, and thus may begin preparation of the orders in substantially real-time.

Issues may arise related to food waste and/or customer experience due to load variability. That is, at times, too many orders may be entered into the control unit 110 such that long wait times may arise. During these periods, the personnel may attempt to compensate for this by making large quantities of food in anticipation of continuing orders at a high volume. However, once a rush dies down, any excess, unserved food may sit for too long, and thus must be discarded. Accordingly, it may be advantageous to have a system or process for anticipating load demands at the restaurant 100 such that waste is minimized while also providing an efficient delivery and/or completion of food orders made by customers within the restaurant.

To enable a predictive food preparation-management system, in accordance with the present disclosure, the restaurant 100 may include one or more sensors for obtaining real-time information or data related to future order demand by customers of the restaurant 100. For example, a first sensor 120 may be arranged to monitor an ordering area 122 to determine the presence of lines of people waiting to make orders. The ordering area 122 is proximate the first service counter 102 within the restaurant 100. The first sensor 120 may be an optical sensor, proximity sensor, people-counting sensor, or other type of sensor as will be appreciated by those of skill in the art. The first sensor 120 is arranged to count the number of customers within the ordering area 122 to determine an anticipated ordering volume. Similarly, a second sensor 124 is arranged to monitor a lobby area 126 in a similar fashion. The information associated with the lobby area 126 can be used to determine if the ordering area 122 may be impacted by additional new customers not yet located within the ordering area 122. However, in such arrangements, the second sensor 124 may be arranged to discount customers that are leaving the restaurant or merely waiting for others in a party to order.

Further, the restaurant 100 can include a third sensor 128 that is arranged to monitor a parking lot 130 of the restaurant 100. The data collected by the third sensor 128 can be used to determine the number of vehicles in the parking lot, detect arriving vehicles, customers walking toward the restaurant, etc. Additionally, a fourth sensor 132 can be arranged to monitor a drive-through area 134 to detect the presence of additional customers located behind a current customer in the drive-through area 134 that may be currently ordering.

The sensors 120, 124, 128, 132 are in communication with the control unit 110. The control unit 110 can then aggregate the collected data from the sensors 120, 124, 128, 132 to determine an anticipated, predictive ordering load that may occur at the restaurant 100. The control unit 110 can then output an anticipated food order schedule to be displayed to personnel within the kitchen 112 and/or may be used for other methods of food preparation. Accordingly, the control unit 110 can make predictive, anticipatory schedules for obtaining food from the food storage area 118, cooking food at the cooking station 114, and assembling food at the staging station 116. In this way, the restaurant 100 can provide an efficient delivery of prepared food to customers while minimizing waste.

The control unit 110 is configured with a program, algorithm, or other programming to enable predictive scheduling in accordance with embodiments of the present disclosure. The control unit 110 includes processes that utilize multiple data sources to predictively determine and output a predictive food preparation schedule (e.g., predictive schedule for food to be prepared). In addition to receiving real-time sensor data from the sensors 120, 124, 128, 132, the control unit 110 can further include analysis of one or more historical data sources, internet or external sources, etc. Historical data can include, but is not limited to, average hourly demand for the past three days at the restaurant 100, hourly demand for the same hour on the same day for the past three years, and/or other historical data associated with food preparation demand and/or scheduling. External sources of data can be associated with physical location of the restaurant 100, proximity to other locations (e.g., mall, retails outlets, hotels, highway exits, schools, etc.), social media sources (e.g., information related to local events, including but not limited to sports events, concerts, parades, etc.), etc. The collected information can then be aggregated at within the control unit 110 to generate a schedule for food preparation. For example, taking all the aggregated data, a prediction of demand needed for food preparation can be generated for a given period of time or event.

Although shown with the control unit 110 located within the restaurant 100, such configuration is not to be limiting. For example, the control unit 110 can be located remote from the restaurant 100, and the predictive food preparation schedule can be transmitted to the restaurant 100, e.g., to a display system within the restaurant 100 to display the predictive food preparation schedule. In some embodiments, the predictive food preparation schedule can be sent to an automated food preparation system (e.g., an automated grill, fryer, salad assembly station, etc.). A remote controller or a remote portion of a controller can be located on one or more remote servers (e.g., “in the cloud”), located at a centralized store, restaurant, headquarters, etc., located as an aggregate of different computing systems located in a collection or group of stores/restaurants (e.g., local or regionally connected locations).

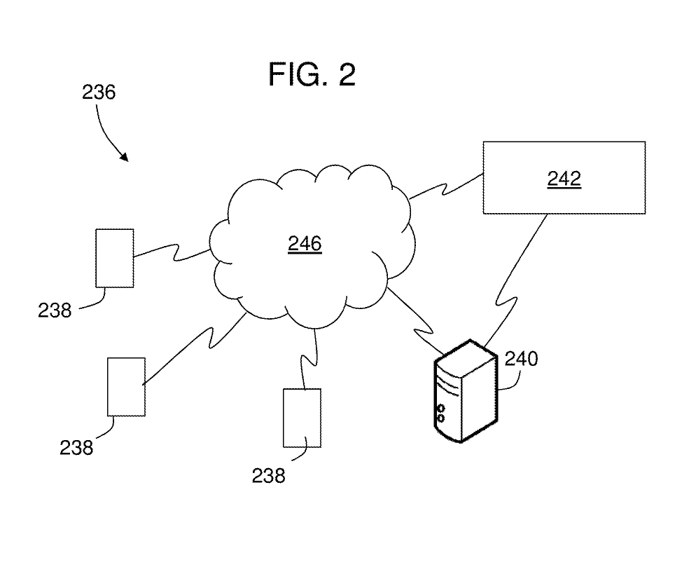

Turning now to FIG. 2, a schematic illustration of a restaurant demand-management system 236 in accordance with an embodiment of the present disclosure is shown. The restaurant demand-management system 236 can include various components, including, but not limited to, one or more sensors 238, one or more point-of-sale systems 240, and a control unit 242 (collectively “electronic devices”). The sensors 238 may be similar to that described with respect to FIG. 1 and may be positioned at various locations associated with a restaurant (e.g., monitoring interior and/or exterior areas or spaces of the restaurant). The control unit 242 can be located within the restaurant and/or located remote therefrom. In some embodiments, the control unit 242 comprises multiple different electronic components, with some components located on-site and other components located off-site. As shown, the various sensors 238, point-of-sale systems 240, and the control unit 242 are operably connected and/or in communication with each other through a network 244, as described herein.

One or more of the electronic devices may include processor(s), memory, communication module(s), etc. as shown and described herein. Communication can be established between the various electronic device can be by wired or wireless communication, through the internet, through a direct connection, etc. as will be appreciated by those of skill in the art.

The sensors 238 and the point-of-sale systems 240 are in communication with the control unit 242. For example, the sensors 238 and the point-of-sale systems 240 and the control unit 242 may communicate with one another when the restaurant is open and orders by customers may be received and/or during preparation time prior to the restaurant being opened. As noted, wired or wires communication may be employed. Wireless communication networks can include, but are not limited to, Wi-Fi, short-range radio (e.g., Bluetooth®), near-field infrared, cellular network, etc. In some embodiments, the control unit 242 may include, or be associated with (e.g., communicatively coupled to), one or more networked system elements, such as computers, routers, network nodes, etc. The networked system element(s) may also communicate directly or indirectly with the sensors 238 and the point-of-sale systems 240 using one or more communication protocols or standards (e.g., through the network 246).

In some embodiments, the control unit 242 (or functionality thereof) can be integrated into the point-of-sale system 240. In such embodiments, the point-of-sale system 240 can communicate with the sensors 238 using near-field communications (NFC) (e.g., network 246) and thus enable communication therebetween. In some embodiments, the control unit 246 and/or the point-of-sale system 240 may establish communication with one or more sensors 238 that are outside of the structure or building of the restaurant. Such connection can be established with various technologies including GPS, triangulation, or signal strength detection, by way of non-limiting example. In example embodiments, the control unit 242 can communicate with the sensors 238 and the point-of-sale systems 240 over multiple independent wired and/or wireless networks. Embodiments are intended to cover a wide variety of types of communication between the control unit 242 and the sensors 238 and the point-of-sale systems 240, and embodiments are not limited to the examples provided in this disclosure.

The network 246 may be any type of known communication network including, but not limited to, wide area networks (WAN), local area networks (LAN), global networks (e.g. Internet), virtual private networks (VPN), cloud networks, intranet, etc. The network 246 may be implemented using a wireless network or any kind of physical network implementation known in the art. The sensors 238 and/or the point-of-sale systems 240 may be coupled to the control unit 242 through one or more networks 246 (e.g., a combination of cellular and Internet connections) so that not all sensors 238 and/or the point-of-sale systems 240 may be coupled to the control unit 242 through the same network 246 at the same time. One or more of the sensors 238 and the control unit 242 may be connected to the network 246 in a wireless fashion. In one non-limiting embodiment, the network 246 is the Internet.

Embodiments provided herein are directed to apparatuses, systems, and methods for collecting data, aggregating said data, and generating a predictive food preparation schedule. In some embodiments, the collected data may be communicated over one or more lines, connections, or networks, such as network 246, e.g., data collected by a sensor 238 and transmitted through the network 246 to the control unit 242. The transmission from the sensor 238 may be transmitted in real-time to the control unit 242.

As provided herein, the control unit 242 can be associated with an automated cooking station and/or a display system for displaying information to personnel of the restaurant. The control unit 242 can be used to aggregate collected data and stored data to generate a predictive food preparation schedule that is predictive and designed to minimize waste while increasing efficiency of delivery of orders from customers. The data can be received through the network 246 from the one or more sensors 238 and/or the point-of-sale systems 240, from local or remote memory, from the internet, etc. One or more of the sensors 238 may be associated with a particular area of observation, which can be weighted differently than other areas of observation (e.g., different weighting of information from different sensors).

As noted above, the control unit of the present disclosure can receive different types of information in generating a predictive food preparation schedule. Data that may be employed by control units of the present disclosure in generating predictive food preparation schedules can include, but is not limited to: real-time orders made at first point-of-sale systems (e.g., counter); orders made at second point-of-sale systems (e.g., drive-through); occupancy sensors (lobby, ordering area, dining area, etc.); sensors monitoring a drive-through line or area; parking lot sensors; historical data (e.g., recent days, year-to-date days, etc.); weather data; social media data; local news data; local event data; day of week information; time of day information; proximity information related to nearby businesses, parks, stadiums, highway exits, etc.; mobile and/or online order information made from remote customers for food from the restaurant; and kiosk ordering within the restaurant.

In some embodiments, the control units can generate predictive food preparation schedules that are applied to automated food preparation systems, e.g., automated grills, etc. Such automated grilling systems can be arranged as continuous-cook-conveyor systems, pick-and-place systems, and/or carousel-to-conveyor systems, for example. Such automated food preparation systems may integrate the separate, personnel-manned stations into a single unit. For example, automated food preparation system can incorporate a food storage station, a cooking station, and a staging station. In such system, raw/uncooked food can be obtained from the food storage station, moved to the cooking station for cooking, and then moved to the staging station for assembly in accordance with an order.

The predictive food preparation schedules generated are a number of items to be prepared at a given time. For example, based on a number of preceding days, the predictive food preparation schedule may indicate that a specific number of a specific food item should be prepared in advance of a specific time or event. In one non-limiting example, at lunch for three days one hundred hamburgers have been ordered within a fifteen minute window, starting at 12:00. On the following day, the predictive food preparation schedule may indicate that at least sixty hamburgers (or more) should be prepared such that they are ready to be served at 12:00.

In some embodiments, the predictive food preparation schedule may be manually overridden. For example, on the fourth day of three sequential days, the predictive food preparation schedule may indicate that a large number of food items should be prepared. However, due to a holiday, business may be slower than anticipated, and thus a user can override the predictive food preparation schedule to prepare fewer than originally predicted numbers of items. Alternatively, a manual override can instruct more than predicted, as needed.

Advantageously, embodiments described herein provide predictive food preparation schedules that enable preparation of food in advance of when the food will be ordered by customers (e.g., an estimated time or event). As such, a reduction of food waste may be achieved by preventing preparing too many items products which may result from human error attempting to manually compensate for a large volume of customers, followed by a large reduction in the number of customers. Further, advantageously, embodiments provided here can improve personnel efficiency because the food preparation will be tied to a predictive schedule based on various input information instead of instantaneous load demands. Moreover, embodiments provided herein may provide an improvement in finished product quality because the cooking stations (e.g., grill) will produce products that are not held for extended periods of time prior to serving.

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A method to generate a predictive food preparation schedule, the method comprising:
obtaining, at a control unit, data from one or more sources associated with a restaurant; and
generating a predictive food preparation schedule based on the obtained data, the predictive food preparation schedule indicating a number of items to be prepared in advance of at least one of a given time and event.

2. The method of claim 1, wherein the one or more sources comprise at least one of: a first point-of-sale system associated with a counter within the restaurant; a second point-of-sale system associated with a drive-through of the restaurant; occupancy sensors associated with one or more areas within the restaurant; monitoring sensors associated with a drive-through line or area; parking lot sensors associated with a parking lot of the restaurant; historical data related to orders made at the restaurant; weather data associated with a location of the restaurant; social media data associated with events in a locale of the restaurant; local news data associated with the locale of the restaurant; event data associated with the locale of the restaurant; day of week information; time of day information; proximity information related to nearby businesses, parks, stadiums, highway exits; mobile and online order information made from remote customers for food from the restaurant; and kiosk ordering within the restaurant.

3. The method of claim 1, further comprising:
displaying the generated predictive food preparation schedule on a display within a kitchen of the restaurant.

4. The method of claim 1, further comprising:
controlling an automated food preparation system based on the predictive food preparation schedule to prepare food in accordance with the predictive food preparation schedule.

5. The method of claim 4, wherein the automated food preparation system is an automated grill system.

6. The method of claim 1, wherein the control unit is located at least one of within the restaurant, located at another restaurant, and located on one or more remote servers.

7. The method of claim 1, further comprising:
receiving a manual input that overrides the predictive food preparation schedule.

8. A method to control an automated food preparation system, the method comprising:
obtaining, at a control unit, data from one or more sources associated with a restaurant;
generating a predictive food preparation schedule based on the obtained data, the predictive food preparation schedule indicating a number of items to be prepared in advance of at least one of a given time and event; and
controlling an automated food preparation system based on the predictive food preparation schedule to prepare food in accordance with the predictive food preparation schedule.

9. The method of claim 8, wherein the one or more sources comprise at least one of: a first point-of-sale system associated with a counter within the restaurant; a second point-of-sale system associated with a drive-through of the restaurant; occupancy sensors associated with one or more areas within the restaurant; monitoring sensors associated with a drive-through line or area; parking lot sensors associated with a parking lot of the restaurant; historical data related to orders made at the restaurant; weather data associated with a location of the restaurant; social media data associated with events in a locale of the restaurant; local news data associated with the locale of the restaurant; event data associated with the locale of the restaurant; day of week information; time of day information; proximity information related to nearby businesses, parks, stadiums, highway exits; mobile and online order information made from remote customers for food from the restaurant; and kiosk ordering within the restaurant.

10. The method of claim 8, further comprising:
displaying the generated predictive food preparation schedule on a display within a kitchen of the restaurant.

11. The method of claim 8, wherein the automated food preparation system is an automated grill system.

12. The method of claim 8, wherein the control unit is located at least one of within the restaurant, located at another restaurant, and located on one or more remote servers.

13. The method of claim 8, further comprising:
receiving a manual input that overrides the predictive food preparation schedule.

14. An automated food preparation system
comprising: a control unit;
a food storage station for holding unprepared food items;
a cooking station for receiving one or more items from the food storage station and cooking the one or more unprepared food items; and
a staging station for preparing and assembling ordered items from the unprepared food items and the cooked food items,
wherein the control unit controls each of the food storage station, the cooking station, and the staging station, and
wherein the control unit obtains data from one or more sources associated with a restaurant and generates a predictive food preparation schedule based on the obtained data, the predictive food preparation schedule indicating a number of items to be prepared in advance of at least one of a given time and event, the control unit controlling the food storage station, the cooking station, and the staging station based on the predictive food preparation schedule.

15. The automated food preparation system of claim 14, wherein the one or more sources comprise at least one of: a first point-of-sale system associated with a counter within the restaurant; a second point-of-sale system associated with a drive-through of the restaurant; occupancy sensors associated with one or more areas within the restaurant; monitoring sensors associated with a drive-through line or area; parking lot sensors associated with a parking lot of the restaurant; historical data related to orders made at the restaurant; weather data associated with a location of the restaurant; social media data associated with events in a locale of the restaurant; local news data associated with the locale of the restaurant; event data associated with the locale of the restaurant; day of week information; time of day information; proximity information related to nearby businesses, parks, stadiums, highway exits; mobile and online order information made from remote customers for food from the restaurant; and kiosk ordering within the restaurant.

16. The automated food preparation system of claim 14, further comprising:
a display for displaying the generated predictive food preparation schedule on a display within a kitchen of the restaurant.

17. The automated food preparation system of claim 14, wherein the cooking station is an automated grill station.

18. The automated food preparation system of claim 14, wherein the control unit is located at least one of within the restaurant, located at another restaurant, and located on one or more remote servers.
